(19) United States
(12) Patent Application Publication
(10) Pub. No.: US 2026/0142377 A1
(43) Pub. Date: May 21, 2026

(54) COMPACT RADIATION PATTERN DECOUPLING DESIGN OF TWO-DIMENSIONAL MIMO MICROSTRIP ANTENNAS

(71) Applicant: City University of Hong Kong, Kowloon (HK)

(72) Inventors: Kwok Wa LEUNG, Kowloon Tong (HK); Guang Yao LIU, Kowloon Tong (HK); Nan YANG, Guangzhou (CN)

(73) Assignee: City University of Hong Kong, Kowloon (HK)

(21) Appl. No.: 18/953,944

(22) Filed: Nov. 20, 2024

(51) Int. Cl. H01Q 9/04

(52) U.S. Cl. CPC H01Q 9/0421

(57) ABSTRACT

A microstrip antenna which includes a substrate, a microstrip patch configured on a first side of the substrate, a ground configured on a second side of the substrate which is opposite to the first side, and a first shorting wall extending from a side of the microstrip patch toward the ground. The first shorting wall substantially overlaps with the substrate on a direction that is perpendicular to the microstrip patch. The first shorting wall is located at a first non-radiating edge of the microstrip antenna. Dummy elements are no longer needed in this design, which makes it compact.

### FIELD OF INVENTION

This invention relates to microstrip antennas and microstrip antenna arrays.

### BACKGROUND OF INVENTION

Multiple-input multiple-output (MIMO) antenna technology has been widely investigated and used to improve communication system capacity and reliability [1], [2]. For ease of fabrication and integration, microstrip antennas (MAs) are highly desired for MIMO antennas [3], [4]. Since the number of antennas increases dramatically, the antenna area is getting limited. Hence, the mutual coupling between the antenna elements will increase and then worsen the S-parameters and radiation performances of a single element. These will further affect the correlation between two antenna elements and the communication quality of the system [5]-[7].

To suppress the mutual coupling levels, different methods have been proposed. As shown in FIGS. 1a-1d, according to the different coupling paths, the decoupling methods can be roughly divided into four categories: 1) metamaterials [8]-[12], dielectric [13], [14], and metal [15] to block the spatially coupled electromagnetic waves; 2) electromagnetic resonance structure for suppressing surface waves, including asymmetric coplanar strip wall [16], microstrip stubs [17], electromagnetic bandgap structure [18]-[20], and split-ring resonator [21]-[23]; 3) defected ground structure [24]-[26] and modified structure [27]-[29] to obtain current null on the ground [30]; 4) neutralization line [31] or decoupling network [32]-[36] to enhance isolations between antenna ports. However, all of the methods mentioned above can be used for isolation enhancement only, and pay little attention to radiation patterns.

To further increase the channel capacity and reliability, radiation patterns should be taken into considerations, which is known as radiation pattern decoupling (RPD). Using common mode and differential mode superposition, inductance or strip can be used for closely spaced 1×2 MAs [37]. Parallel shorting posts are used to form a matching and decoupling network with an isolation larger than 27 dB [38]. To further reduce the overall antenna size, two MAs are connected together with a zero edge-to-edge spacing, with superpositions of TM₀₂/TM₀₃ [39] and TM₀₁/TM₁ᵢ[40] modes. Composed of parasitic ports and reactive loads, loaded resonators are used for decoupling of 2×2 MIMO antenna system [41]. Thus far, these methods can be applied for 1×2 or 2×2 MIMO antennas only.

Very recently, shorting pins are used for RPD characteristic of a 4×4 MIMO antenna system [42]. To preserve the radiation patterns of the outer elements, dummy units are required. In addition, almost all existing antenna decoupling methods have focused on port isolation, and the radiation patterns so obtained are usually distorted. This distortion can strongly affect their applications, e.g., the line-of-sight transmission.

### REFERENCES

The following references are referred to throughout this specification, as indicated by the numbered brackets. The disclosures of each of these references are hereby incorporated by reference herein in their entireties for all purposes.
[1] L. Lu, G. Y. Li, A. L. Swindlehurst, A. Ashikhmin and R. Zhang, “An overview of massive MIMO: benefits and challenges,” IEEE J. Sel. Top. Signal Process., vol. 8, no. 5, pp. 742-758, October 2014.
[2] E. G. Larsson, O. Edfors, F. Tufvesson and T. L. Marzetta, “Massive MIMO for next generation wireless systems,” IEEE Commun. Mag., vol. 52, no. 2, pp. 186-195, February 2014.
[3] L. Liu, S. W. Cheung and T. I. Yuk, “Compact MIMO antenna for portable devices in UWB applications,” IEEE Trans. Antennas Propag., vol. 61, no. 8, pp. 4257-4264, August 2013.
[4] M. S. Sharawi, Printed MIMO antenna engineering, Boston, MA, USA: Artech House, 2001.
[5] R. Chataut and R. J. S. Akl, “Massive MIMO systems for 5G and beyond networks-overview, recent trends, challenges, and future research direction,” Sensors, vol. 20, no. 10, pp. 2753-2788, May 2020.
[6] H. Makimura, K. Nishimoto, T. Yanagi, T. Fukasawa and H. Miyashita, “Novel decoupling concept for strongly coupled frequency-dependent antenna arrays,” IEEE Trans. Antennas Propag., vol. 65, no. 10, pp. 5147-5154, October 2017.
[7] C. Volmer, J. Weber, R. Stephan, K. Blau and M. A. Hein, “An eigen-analysis of compact antenna arrays and its application to port decoupling,” IEEE Trans. Antennas Propag., vol. 56, no. 2, pp. 360-370, February 2008.
[8] K.-L. Wu, C. Wei, X. Mei, and Z.-Y. Zhang, “Array-antenna decoupling surface,” IEEE Trans. Antennas Propag., vol. 65, no. 12, pp. 6728-6738, December 2017.
[9] H. Luan, C. Chen, W. Chen, L. Zhou, H. Zhang and Z. Zhang, “Mutual coupling reduction of closely E/H-plane coupled antennas through metasurfaces,” IEEE Antennas Wireless Propag. Lett., vol. 18, no. 10, pp. 1996-2000, October 2019.
[10] M. Alibakhshikenari et al., “A comprehensive survey on “various decoupling mechanisms with focus on metamaterial and metasurface principles applicable to SAR and MIMO antenna systems”,” IEEE Access, vol. 8, pp. 192965-193004, October 2020.
[11] A. Jafargholi, A. Jafargholi, and J. H. Choi, “Mutual coupling reduction in an array of patch antennas using CLL metamaterial superstrate for MIMO applications,” IEEE Trans. Antennas Propag., vol. 67, no. 1, pp. 179-189, January 2019.
[12] M. Sigalov, R. Shavit, R. Joffe and E. O. Kamenetskii, “Manipulation of the radiation characteristics of a patch antenna by small ferrite disks inserted in its cavity domain,” IEEE Trans. Antennas Propag., vol. 61, no. 5, pp. 2371-2379, May 2013.
[13] P. Mei, Y.-M. Zhang and S. Zhang, “Decoupling of a wideband dual-polarized large-scale antenna array with dielectric stubs,” IEEE Trans. Veh. Technol., vol. 70, no. 8, pp. 7363-7374, September 2021.
[14] M. Li, M. Y. Jamal, L. Jiang and K. L. Yeung, “Isolation enhancement for MIMO patch antennas sharing a common thick substrate: using a dielectric block to control space-wave coupling to cancel surface-wave coupling,” IEEE Trans. Antennas Propag., vol. 69, no. 4, pp. 1853-1863, April 2021.
[15] J. Shi, X. Geng, S. Yan, K. Xu, and Y. Chen, “An approach to achieving multiple mutual coupling nulls in MIMO stacked patch antenna for decoupling bandwidth enhancement,” IEEE Trans. Circuits Syst. II, Exp. Briefs, vol. 69, no. 12, pp. 4809-4813, December 2022.
[16] K. S. Vishvaksenan, K. Mithra, R. Kalaiarasan and K. S. Raj, “Mutual coupling reduction in microstrip patch antenna arrays using parallel coupled-line resonators,” IEEE Antennas Wireless Propag. Lett., vol. 16, pp. 2146-2149, May 2017.
[17] K. Wei and B. Zhu, “The novel W parasitic strip for the circularly polarized microstrip antennas design and the mutual coupling reduction between them,” IEEE Trans. Antennas Propag., vol. 67, no. 2, pp. 804-813, February 2019.
[18] F. Yang and Y. Rahmat-Samii, “Microstrip antennas integrated with electromagnetic band-gap (EBG) structures: A low mutual coupling design for array applications,” IEEE Trans. Antennas Propag., vol. 51, no. 10, pp. 2936-2946, October 2003.
[19] X. Yang, Y. Liu, Y.-X. Xu and S.-X. Gong, “Isolation enhancement in patch antenna array with fractal UC-EBG structure and cross slot,” IEEE Antennas Wireless Propag. Lett., vol. 16, pp. 2175-2178, May 2017.
[20] X. Shen, Y. Liu, L. Zhao, G.-L. Huang, X. Shi and Q. Huang, “A miniaturized microstrip antenna array at 5G millimeter-wave band,” IEEE Antennas Wireless Propag. Lett., vol. 18, no. 8, pp. 1671-1675, August 2019.
[21] A. Habashi, J. Nourinia, and C. Ghobadi, “Mutual coupling reduction between very closely spaced patch antennas using low-profile folded split-ring resonators (FSRRs),” IEEE Antennas Wireless Propag. Lett., vol. 10, pp. 862-865, August 2011.
[22] M. Li, X. Chen, A. Zhang, W. Fan and A. A. Kishk, “Split-ring resonator-loaded baffles for decoupling of dual-polarized base station array,” IEEE Antennas Wireless Propag. Lett., vol. 19, no. 10, pp. 1828-1832, October 2020.
[23] Faizan Faraz et al., “Mutual coupling reduction of dual polarized low profile MIMO Antenna using decoupling resonators”, Appl. Comput. Electrom., vol. 35, no. 1, pp. 38-43, January 2020.
[24] B. Qian, X. Huang, X. Chen, M. Abdullah, L. Zhao and A. A. Kishk, “Surrogate-assisted defected ground structure design for reducing mutual coupling in 2×2 microstrip antenna array,” IEEE Antennas Wireless Propag. Lett., no. 2, pp. 351-355, February 2022.
[25] D. Gao, Z.-X. Cao, S.-D. Fu, X. Quan and P. Chen, “A novel slot-array defected ground structure for decoupling microstrip antenna array,” IEEE Trans. Antennas Propag., vol. 68, no. 10, pp. 7027-7038, October 2020.
[26] K. Wei, J.-Y. Li, L. Wang, Z.-J. Xing and R. Xu, “Mutual coupling reduction by novel fractal defected ground structure bandgap filter,” IEEE Trans. Antennas Propag., vol. 64, no. 10, pp. 4328-4335, October 2016.
[27] H. Lin, Q. Chen, Y. Ji, X. Yang, J. Wang and L. Ge, “Weak-field-based self-decoupling patch antennas,” IEEE Trans. Antennas Propag., vol. 68, no. 6, pp. 4208-4217, June 2020.
[28] K.-L. Wong and G.-L. Yan, “Wideband three-port equilateral triangular patch antenna generating three uncorrelated waves for 5G MIMO access points,” IEEE Access, vol. 10, pp. 893-899, December 2022.
[29] Q. X. Lai, Y. M. Pan, S. Y. Zheng and W. J. Yang, “Mutual Coupling Reduction in MIMO Microstrip Patch Array Using TM10 and TM02 Modes,” IEEE Trans. Antennas Propag, vol. 69, no. 11, pp. 7562-7571, November 2021
[30] Q. X. Lai, Y. M. Pan and S. Y. Zheng, “A Self-Decoupling Method for MIMO Antenna Array Using Characteristic Mode of Ground Plane,” IEEE Trans. Antennas Propag., vol. 71, no. 3, pp. 2126-2135, March 2023.
[31] M. Li, L. Jiang and K. L. Yeung, “A general and systematic method to design neutralization lines for isolation enhancement in MIMO antenna arrays,” IEEE Trans. Veh. Technol., vol. 69, no. 6, pp. 6242-6253, June 2020.
[32] B. C. Pan and T. J. Cui, “Broadband decoupling network for dual-band microstrip patch antennas,” IEEE Trans. Antennas Propag., vol. 65, no. 10, pp. 5595-5598, October 2017.
[33] Y.-M. Zhang and S. Zhang, “A Novel aperture-loaded decoupling concept for patch antenna arrays,” IEEE Trans. Microw. Theory Tech., vol. 69, no. 9, pp. 4272-4283, September 2021.
[34] A. Zhang, K. Wei, S. Chu and Y. Wang, “Extremely compact interconnected half-mode cavity antennas with enhanced isolation for MIMO system,” IEEE Trans. Antennas Propag., vol. 70, no. 12, pp. 12264-12269, December 2022.
[35] K.-R. Xiang, F.-C. Chen, Y.-Z. Liang and Q.-X. Chu, “Dual-polarized cavity-backed full metal antennas for in-band full-duplex application,” IEEE Trans. Antennas Propag., (accepted; available in IEEE Explore)
[36] L. Sun, Y. Li, Z. Zhang and H. Wang, “Antenna decoupling by common and differential modes cancellation,” IEEE Trans. Antennas Propag., vol. 69, no. 2, pp. 672-682, February 2021
[37] L. Sun, Y. Li, and Z. Zhang, “Decoupling between extremely closely spaced patch antennas by mode cancellation method,” IEEE Trans. Antennas Propag., vol. 69, no. 6, pp. 3074-3083, June 2021.
[38] R. Zaker and A. Kheirdoost, “Bandwidth and isolation improvement of highly coupled printed array antenna using multiple shorting posts,” IEEE Trans. Antennas Propag., vol. 69, no. 11, pp. 7987-7992, November 2021.
[39] C. Guo, J. Li, D. Yang and H. Zhai, “Compact co-polarized decoupled microstrip patch array antenna based on TM02/TM03 modes cancellation,” IEEE Trans. Antennas Propag., vol. 70, no. 10, pp. 9906-9911, October 2022.
[40] J. Wu, C. Tong, N. Yang, K. W. Leung, K. Lu and P. Hu, “Radiation pattern decoupled patch antennas based on TM01 and TM11 modes,” IEEE Antennas Wireless Propag. Lett., vol. 22, no. 11, pp. 2695-2699, November 2023.
[41] Y.-F. Cheng and K.-K. M. Cheng, “Decoupling of 2×2 MIMO antenna by using mixed radiation modes and novel patch element design,” IEEE Trans. Antennas Propag., vol. 69, no. 12, pp. 8204-8213, December 2021.
[42] G. Liu, N. Yang, K. W. Leung, and K. M. Luk, “A full design perspective of port decoupling for MIMO antenna: preservation of radiation pattern,” IEEE Trans. Antennas Propag., under review.
[43] Liang, J. Lai, Y. Li, J. Liu and Y. Long, “Low-cost and high-gain microstrip magnetic dipole antenna with all-metal structure and open-ended stubs,” IEEE Trans. Antennas Propag., vol. 69, no. 6, pp. 3543-3548, June 2021.
[44] N. Liu, L. Zhu, W. Choi and X. Zhang, “A low-profile aperture-coupled microstrip antenna with enhanced bandwidth under dual resonance,” IEEE Trans. Antennas Propag., vol. 65, no. 3, pp. 1055-1062, March 2017.
[45] C. A. Balanis, Antenna Theory: Analysis and Design, Hoboken, NJ, USA:Wiley, 2005.
[46] D. M. Pozar, Microwave Engineering, Hoboken, NJ, USA:Wiley, 2011.
[47] R. Garg, Microstrip antenna design handbook, Boston, MA, USA: Artech House, 2001.
[48] N. Yang, K. W. Leung and N. Wu, “Pattern-diversity cylindrical dielectric resonator antenna using fundamental modes of different mode families,” IEEE Trans. Antennas Propag., vol. 67, no. 11, pp. 6778-6788, November 2019.
[49] M. Abdullah, S. H. Kiani and A. Iqbal, “Eight element multiple-input multiple-output (MIMO) antenna for 5G mobile applications,” IEEE Access, vol. 7, pp. 134488-134495, September 2019.
[50] D. M. Pozar, “Microstrip antennas,” Proc. IEEE, vol. 80, no. 1, pp. 79-91, January 1992.

### SUMMARY OF INVENTION

Accordingly, the present invention, in one aspect, provides a microstrip antenna which includes a substrate, a microstrip patch configured on a first side of the substrate, a ground configured on a second side of the substrate which is opposite to the first side, and a first shorting wall extending from a side of the microstrip patch toward the ground. The first shorting wall substantially overlaps with the substrate on a direction that is perpendicular to the microstrip patch. The first shorting wall is located at a first non-radiating edge of the microstrip antenna.

In some embodiments, the first shorting wall is located at an edge of the microstrip patch.

In some embodiments, the microstrip antenna further contains a second shorting wall that extends from the side of the microstrip patch toward the ground. The second shorting wall is symmetrical to the first shorting wall and located at a second non-radiating edge of the microstrip antenna that is opposite to the first non-radiating edge.

In some embodiments, the microstrip patch is formed with a U-shaped strip near a first radiating edge of the microstrip antenna.

In some embodiments, the microstrip patch is formed with a U-shaped slot, with a central portion of the U-shaped slot located near a second radiating edge of the microstrip antenna.

In some embodiments, for the U-shaped slot the central portion has a width greater than that of two side portions of the U-shaped slot. The central portion connects the two side portions.

In some embodiments, the U-shaped slot further includes two side portions with the central portion connecting the two side portions. The first shorting wall is located near one of the two side portions of the U-shaped slot.

In some embodiments, the one of the two side portions of the U-shaped slot is located inwardly of the first shorting wall toward a center of the microstrip patch.

In some embodiments, the microstrip patch is formed with a U-shaped strip near a first radiating edge of the microstrip antenna which is opposite to the second radiating edge.

In some embodiments, the U-shaped strip forms an elongated slot the length of which is substantially the same as a span of the U-shaped slot in the direction along which the central portion extends.

In some embodiments, the microstrip antenna further contains third and fourth shorting walls that extends from the side of the microstrip patch toward the ground. The third shorting wall is substantially symmetrical to the fourth shorting wall about a center of the microstrip patch. The third and fourth shorting walls are perpendicular to the first and second shorting walls.

According to another aspect of the invention, there is provided a microstrip antenna array, which includes a first substrate, an even number of microstrip patches configured on a first side of the first substrate; and a ground configured on a second side of the first substrate which is opposite to the first side. Each one of the microstrip patches includes a first shorting wall extending from a side of the microstrip patch toward the ground. The first shorting wall substantially overlaps with the first substrate on a direction that is perpendicular to the microstrip patch. The first shorting wall is located at a first non-radiating edge of the microstrip patch.

In some embodiments, each one of the microstrip patches further contains a second shorting wall that extends from the side of the microstrip patch toward the ground. The second shorting wall is symmetrical to the first shorting wall and located at a second non-radiating edge of the microstrip patch that is opposite to the first non-radiating edge.

In some embodiments, each of the microstrip patches is formed with a U-shaped strip near a first radiating edge of the microstrip patch.

In some embodiments, each of the microstrip patches is formed with a U-shaped slot, with a central portion of the U-shaped slot located near a second radiating edge of the microstrip patch.

In some embodiments, the microstrip antenna array further contains a third shorting wall that is substantially perpendicular to the first shorting wall. The third shorting wall extends beside at least two of the microstrip patches that are aligned side by side with each other.

In some embodiments, at least two of the microstrip patches are electrically connected to each other at a location near the first shorting wall.

In some embodiments, the microstrip antenna array further contains a second substrate. The ground is located between the first substrate and the second substrate. The ground is configured on a first side of the second substrate.

In some embodiments, the first substrate and the second substrate are bonded by a bonding film.

In some embodiments, the microstrip antenna array further contains a microstrip line located at a second side of the second substrate which is opposite to the first side of the second substrate.

In some embodiments, the microstrip line has a substantially L shape.

In some embodiments, the microstrip line contains an open-circuited stub and stepped impedance lines.

According to another aspect of the invention, there is provided an RPD method for compact 2D MIMO MA array without using dummy elements. The antenna element is loaded with two shorting walls at the non-radiating edges, whose working mode is a new TE^{x}₁₁₀ mode. With extra current paths introduced by U-shaped strips and slots, H- and E-plane RPD characteristics can be in turn obtained based on the coupling superposition principle. Four shorting walls have been used to obtain boundary uniformity for each element even without using dummy elements. A 4×4 MIMO antenna array is also designed to prove the decoupling capability for two-dimensional MIMO array. Notably, the radiation patterns of each element feature the RPD characteristics, which is promising for large-scale MIMO or array antennas. In addition, this design method is also applicable to millimeter wave or terahertz frequency bands.

In some embodiments, the separation between the radiators in the module can be flexibly set.

In some embodiments, the RPD method using U-shaped strips and slots can be applied to decouple antennas on the H-plane and E-plane.

In some embodiments, the shorting walls help the 2D MIMO antenna array to obtain the RPD characteristics without using dummy elements.

In some embodiments, the operating frequency can be changed to other frequency bands;

In some embodiments, the short-circuit wall used can be replaced by other conductors, such as vias, and prisms.

In some embodiments, the shape of the antenna can be other forms, such as rectangular, circular, etc.

In some embodiments, dielectric constants of the substrate can be changed to other values.

In some embodiments, feed structure of the antenna can be in other forms, such as L-shaped probe, and T-shaped coupled strip.

In some embodiments, the U-shaped strips and slots can be replaced by other equivalent shapes, such as arcs, diamonds, etc.

In some embodiments, the number of elements in the MIMO antenna array can be two, sixteen, or above.

In some embodiments, a 2-D 4×4 MIMO antenna array can be regarded as a subarray in a large scale 2-D array.

One can see that exemplary embodiments of the invention therefore provide a RPD method for compact 2D MIMO MA array without using dummy elements. With H-plane-placed shorting walls, the MA element works under its TE₁₁₀^{x} mode. Also, a smaller H-plane spacing can be obtained in the array designs, which further reduces the overall size.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1a is a schematic diagram showing spatial couplings of two MAs in one example.

FIG. 1b is a schematic diagram showing surface-waves coupling of two MAs in another example.

FIG. 1c is a schematic diagram showing currents-on-ground coupling of two MAs in a further example.

FIG. 1d is a schematic diagram showing feeding-networks coupling of two MAs in a further example.

FIG. 2a shows the side view of a MA according to one embodiment of the invention.

FIG. 2b shows the top view of the MA in FIG. 2a.

FIG. 2c shows a perspective view of the MA in FIG. 2a, with the substrate and the ground hidden for clarity.

FIG. 3a shows a schematic diagram of an exemplary MA working under TE₁₁₀^{x} mode, along with surface current distribution of its microstrip patch.

FIG. 3b shows a schematic diagram of the exemplary MA of FIG. 3a working under TE₁₁₀^{x} mode, along with E-filed and H-filed distributions of the MA.

FIG. 4a shows the schematic diagram of surface currents on patches of H-plane-placed 1×2 MAs without U-shaped strips.

FIG. 4b shows the schematic diagram of surface currents on patches of H-plane-placed 1×2 MAs with U-shaped strips.

FIG. 5 shows simulated H-plane co-polarizations of various MAs (1×1, 1×2, with U-shaped strip, without U-shaped strip), which are normalized at 5.8 GHz for Port 1.

FIG. 6a shows a schematic diagram of surface currents on patches of E-plane-placed 1×2 MAs, without U-shaped slots.

FIG. 6b shows a schematic diagram of surface currents on patches of E-plane-placed 1×2 MAs, with U-shaped slots.

FIG. 6c shows radiating edge spacing between two decoupled MA elements.

FIG. 7a shows simulated E-plane co-polarizations of various MAs (1×1, 1×2, with U-shaped slot, without U-shaped slot) normalized at 5.8 GHz, with Port 1 excited and Port 2 loaded.

FIG. 7b shows simulated E-plane co-polarizations of various MAs (1×1, 1×2, with U-shaped slot, without U-shaped slot) normalized at 5.8 GHz, with Port 2 excited and Port 1 loaded.

FIG. 8a shows a side view of a MA element in a 4×4 MIMO MA array according to one embodiment of the invention.

FIG. 8b shows the top view of the MA element in FIG. 8a.

FIG. 8c shows the top view of the ground plane as well as the microstrip feedline of the MA element in FIG. 8a.

FIG. 8d is a perspective view of the 4×4 MIMO MA array.

FIG. 9a shows measured (on a prototype) and simulated reflection coefficients of Ports 1, 2, 5, and 6 for the 4×4 decoupled MA array of FIGS. 8a-8d.

FIG. 9b shows measured and simulated transmission coefficients of Port 1 for the 4×4 decoupled MA array of FIGS. 8a-8d.

FIG. 9c shows measured and simulated transmission coefficients of Port 2 for the 4×4 decoupled MA array of FIGS. 8a-8d.

FIG. 9d shows measured and simulated transmission coefficients of Port 5 for the 4×4 decoupled MA array of FIGS. 8a-8d.

FIG. 9e shows measured and simulated transmission coefficients of Port 6 for the 4×4 decoupled MA array of FIGS. 8a-8d.

FIG. 10a shows measured and simulated normalized radiation patterns for Port 1 for the 4×4 decoupled MA array of FIGS. 8a-8d.

FIG. 10b shows measured and simulated normalized radiation patterns for Port 2 for the 4×4 decoupled MA array of FIGS. 8a-8d.

FIG. 10c shows measured and simulated normalized radiation patterns for Port 5 for the 4×4 decoupled MA array of FIGS. 8a-8d.

FIG. 10d shows measured and simulated normalized radiation patterns for Port 6 for the 4×4 decoupled MA array of FIGS. 8a-8d.

FIG. 11 illustrates measured and simulated realized gains of the 4×4 decoupled MA array of FIGS. 8a-8d.

FIG. 12 illustrates measured and simulated total radiation efficiencies of the 4×4 decoupled MA array of FIGS. 8a-8d.

FIG. 13a shows measured and simulated ECC at Port 1 for the 4×4 decoupled MA array of FIGS. 8a-8d.

FIG. 13b shows measured and simulated ECC at Port 2 for the 4×4 decoupled MA array of FIGS. 8a-8d.

FIG. 13c shows measured and simulated ECC at Port 5 for the 4×4 decoupled MA array of FIGS. 8a-8d.

FIG. 13d shows measured and simulated ECC at Port 6 for the 4×4 decoupled MA array of FIGS. 8a-8d.

FIG. 14 is a table showing performance comparison of the prototype of the 4×4 decoupled MA array of FIGS. 8a-8d with other related works.

FIG. 15 is a table showing performances of 2×2 MIMO MA arrays with different decoupling schemes.

FIG. 16a shows simulated radiation patterns of Port 1 at 5.75 GHz without E-plane shorting walls for a 2×2 MIMO MA array.

FIG. 16b shows simulated radiation patterns of Port 1 at 5.75 GHz without E-plane shorting walls for a 4×4 MIMO MA array.

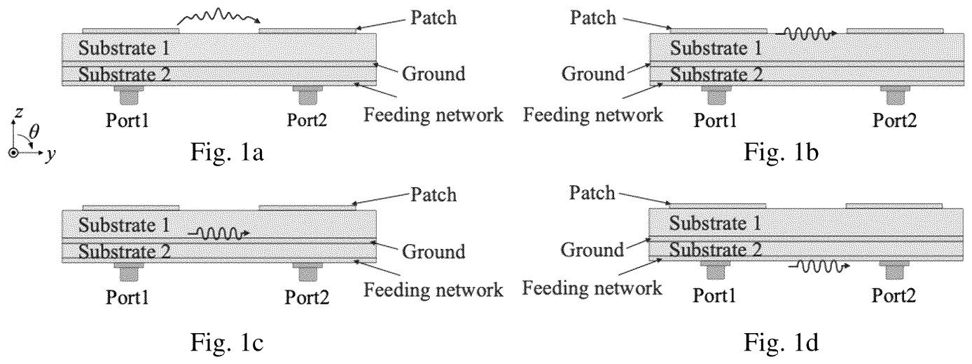

### DETAILED DESCRIPTION

Spatial descriptions, such as “on,” “above,” “below,” “up,” “left,” “right,” “down,” “top,” “bottom,” “vertical,” “horizontal,” “side,” “higher,” “lower,” “upper,” “over,” “under,” and so forth, are specified with respect to a certain component or group of components, or a certain plane of a component or group of components, for the orientation of the component(s) as shown in the associated figure. It should be understood that the spatial descriptions used herein are for purposes of illustration only, and that practical implementations of the structures described herein can be spatially arranged in any orientation or manner, provided that the merits of embodiments of this disclosure are not deviated from by such arrangement.

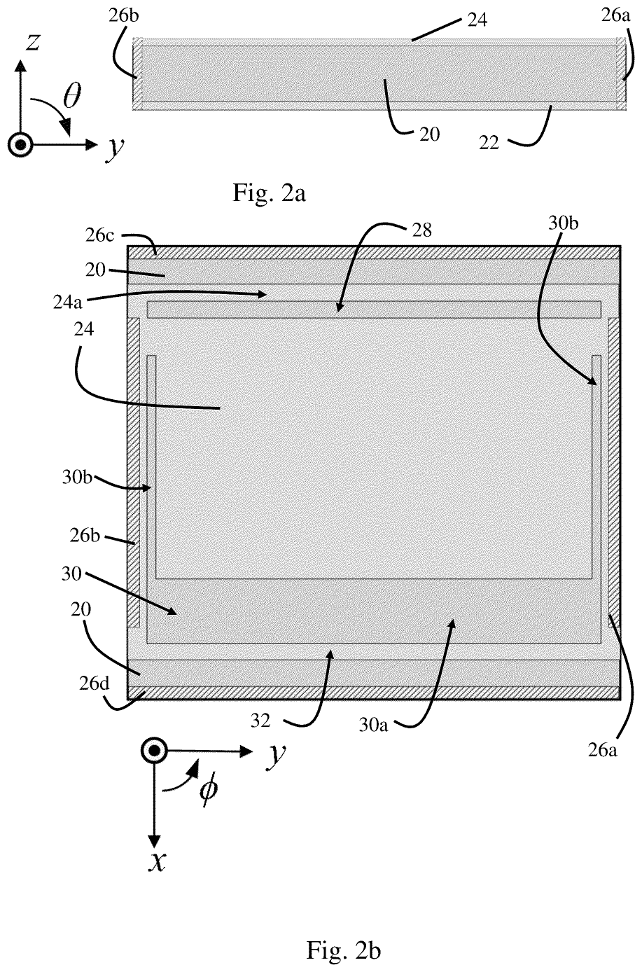

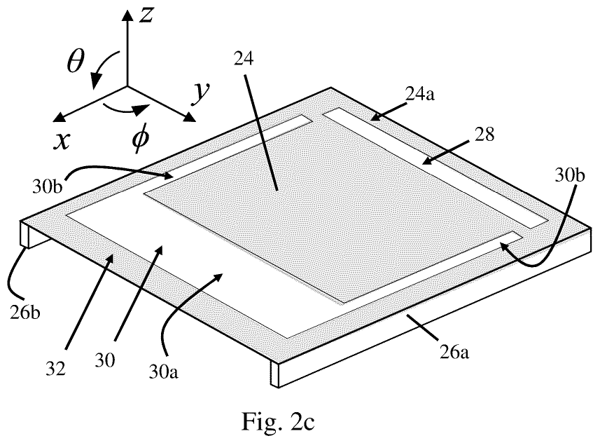

Referring to FIG. 2a-2c, the first embodiment of the invention is a compact two-dimensional MIMO microstrip antenna. The MA contains a substrate 20, a microstrip patch 24 configured on a top side of the substrate 20 (taking the z direction as the vertical direction), and a ground 22 configured on a bottom side of the substrate 20. Running alongside the substrate 20 are two shorting walls 26a, 26b each of which having a longitudinal direction parallel to the x direction, while also extending in the z direction. As can be best seen in FIG. 2a, each of the two shorting walls 26a, 26b substantially overlaps with the substrate 20 on the z direction, as they extend from the microstrip patch 24 toward the ground 22. The microstrip patch 24 and the ground 22 are both perpendicular to the z direction. In addition, as can be seen from FIGS. 2a-2b, the two shorting walls 26a, 26b are respectively located at two opposite edges of the microstrip patch 24, and are separated from each other on the y direction. In fact, the two shorting walls 26a, 26b are aligned with respective edges of the microstrip patch 24, which correspond respectively to a first and a second non-radiating edges (which are the left and right edges in FIGS. 2a-2b) of the MA.

Among the four edges of the MA, the other two edges which are not adjacent to the shorting walls 26a, 26b are radiating edges of the MA. In particular, at a first radiating edge of the MA (which is the upper edge of the MA in FIG. 2b), the microstrip patch 24 is formed with a U-shaped strip 24a which extends from the rest of the microstrip patch 24 in the x direction and spans the same distance as the rest of the microstrip patch 24 on the y direction. The U-shaped strip 24a contains two right-angle bends. As the U-shaped strip 24a is offset from the rest of the microstrip patch 24, an elongated slot 28 is formed therebetween, which extends in the y direction. FIG. 2b shows both the elongated slot 28, and part of the substrate 20 that can be seen through the elongated slot 28.

On the other side, at the lower edge of the microstrip patch 24 as shown in FIG. 2b (which is near a second radiating edge of the MA), there is a U-shaped slot 30 formed for example by etching the microstrip patch 24. FIG. 2b also shows both the U-shaped slot 30 as well as part of the substrate 20 that can be seen through the U-shaped slot 30. The U-shaped slot 30 has a similar geometrical shape as the U-shaped strip 24a mentioned above, except that one is hollow, and the other one is solid. In fact, as part of the microstrip patch 24 there is also another U-shaped strip 32 that is formed as a result of forming the U-shaped slot 30, which is adjacent to and enclosing the U-shaped slot 30. The U-shaped strip 32 forms a microstrip line that provides an extra current path.

There are three portions of the U-shaped slot 30, which includes two side portions 30b, and a central portion 30a connecting the two side portions 30b. One can see from FIG. 2b that within the U-shaped slot 30, the central portion 30a has a width greater than that of two side portions 30b. Also, compared to the U-shaped strip 24a, the U-shaped slot 30, while having the same span along the y direction with the U-shaped strip 24a, has a much larger dimension along the x direction. The U-shaped slot 30 also has two right-angle bends, which together with the U-shaped strip 24a maintain the overall rectangular shape of the microstrip patch 24. Moreover, one can see from FIG. 2b that the two shorting walls 26a, 26b at the non-radiating edges of the MA are located outwardly as compared to the two side portions 30b of the U-shaped slot 30 with respect to a center (not shown) of the microstrip patch 24. The elongated slot 28 has a length which is substantially the same as the span of the U-shaped slot 30 in the y direction.

At the two radiating edges of the MA, there are two additional shorting walls 26c, 26d, both of which are separated from the microstrip patch 24 along the x direction. In particular, the shorting wall 26c is further offset from the center of the microstrip patch 24 along the x direction than the U-shaped strip 24a. Likewise, the shorting wall 26d is further offset from the center of the microstrip patch 24 along the x direction than the U-shaped slot 30. Like the shorting walls 26a, 26b, the shorting walls 26c, 26d also extend in the z direction from the microstrip patch 24 toward the ground 22. The shorting walls 26c, 26d are symmetrical to each other about the center of the microstrip patch 24, and have greater lengths as compared to the shorting walls 26a, 26b. The shorting walls 26c, 26d are perpendicular to the shorting walls 26a, 26b.

Having described the structure of the MA in FIGS. 2a-2c, the design process and working principle of the MA will now be described. In summary, with the two shorting walls 26a, 26b loaded at its non-radiating edges, the MA works under the fundamental

$$T {E}_{110}^{x}$$

mode, and it will be analyzed under the fundamental

$$T {E}_{110}^{x}$$

mode with a cavity model. The U-shaped strip 24a is added to the patches and introduce extra coupling current path, which can be used to cancel the current on the H-plane-coupled patch and obtain RPD characteristic. For the E-plane-coupled case, the extra U-shaped slot 30 is etched on the microstrip patch 24, which can further fine tune the coupling coefficient between adjacent MA elements. With the extra current paths introduced by the U-shaped strip 24a and the U-shaped slot 30, H- and E-plane RPD characteristics can be in turn obtained based on the superposition principle.

To preserve the element radiation patterns at the corner of a MIMO array, the shorting walls 26c, 26d are also inserted close to the radiating edges. For the MA shown in FIGS. 2a-2c, four shorting walls 26a-26d in total can make the element performance insensitive to the surroundings. Therefore, dummy elements are no longer needed for the MA, which makes it compact. As will be described later, a prototype of a microstrip antenna array with 4×4 antenna elements each of which is based on the MA shown in FIGS. 2a-2c is designed, fabricated, and measured for 5.8-GHz band. The measured results show good agreement with the simulated ones. A measured overlapping impedance bandwidth of 5.9% can be obtained, over which the isolation is higher than 18.7 dB between any two ports. It should be highlighted that this compact MIMO array features RPD characteristic even without dummy elements, thus being promising for practical applications.

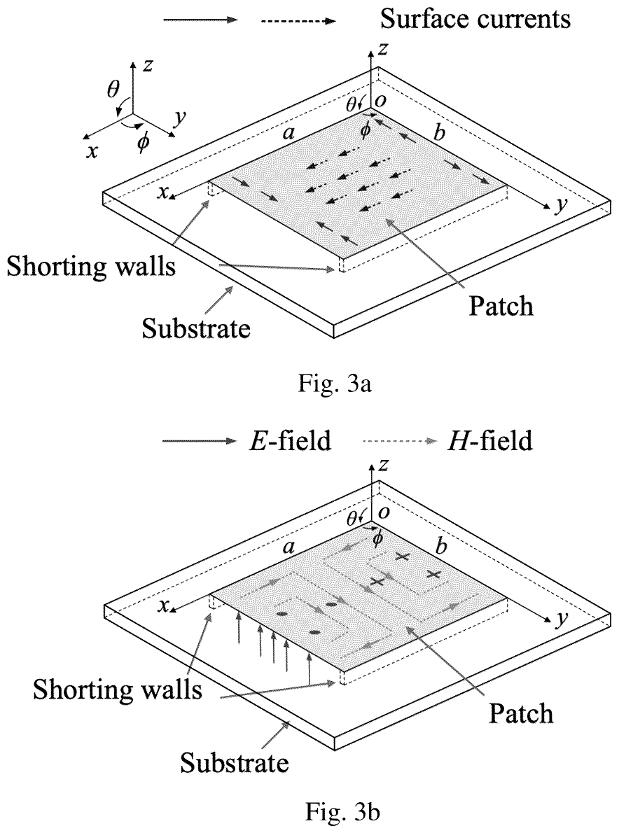

The working principle of the MA in FIGS. 2a-2c based on the TE₁₁₀^{x} mode will now be described. For ease of 2D extension and insensitivity to ground size, two shorting walls are located at the non-radiating edges of an MA as shown in FIGS. 3a-3c. A rectangular waveguide cavity model could be formed with four electric conductors (perpendicular to y- and z-axes) and two magnetic walls (perpendicular to x-axis). With this model, the E- and H-field distributions can be obtained as follows [43], [44], when the fundamental TE₁₁₀^{x} mode is considered,

$$\{ \begin{matrix}{E}_{x} = 0 \\ {E}_{y} = 0 \\ {E}_{z} = - {E}_{0} cos ( \frac{π}{a} x ) sin ( \frac{π}{b} y )\end{matrix} \qquad ( 1 )$$

$$\{ \begin{matrix}{H}_{x} = j \frac{π}{ω μ b} {E}_{0} cos ( \frac{π}{a} x ) cos ( \frac{π}{b} y ) \\ {H}_{y} = j \frac{π}{ω μ a} {E}_{0} sin ( \frac{π}{a} x ) sin ( \frac{π}{b} y ) \\ {H}_{z} = 0\end{matrix} \qquad ( 2 )$$

where a and b denote the lengths of the cavity along x- and y-axes, respectively. With these E- and H-field distribution formulae, the surface current distribution and its resonant frequency can be obtained easily as,

$$\{ \begin{matrix}{J}_{x} = j \frac{π}{ω μ a} {E}_{0} sin ( \frac{π}{a} x ) sin ( \frac{π}{b} y ) \\ {J}_{y} = - j \frac{π}{ω μ b} {E}_{0} cos ( \frac{π}{a} x ) cos ( \frac{π}{b} y ) \\ {J}_{z} = 0\end{matrix} \qquad ( 3 )$$

$${f}_{110} = \frac{c}{2 \sqrt{{μ}_{r} {ε}_{r}}} \sqrt{{( \frac{1}{a} )}^{2} + {( \frac{1}{b} )}^{2}} \qquad ( 4 )$$

where c, εᵣ, and μᵣ represent speed of light, relative permittivity, and relative permeability, respectively.

With these expressions, the current and field distributions inside this cavity can be plotted in FIGS. 3a and 3b, respectively. With reference to FIG. 3a, the surface currents have x-oriented components, which are similar to those of conventional TM₁₀₀^{z} mode [45] of an MA. However, y-oriented currents can be only found for the TE₁₁₀^{x} mode [46]. As can be seen in FIG. 3b, E- and H-field distributions inside the cavity are very similar to those of a rectangular cavity resonator under its fundamental mode [47].

With these E-field distributions, two y-directed magnetic currents can be equivalent with a spacing of 0.5λ_{g}, which generates a unidirectional radiation pattern like a conventional MA. It should be mentioned that the shorting walls make it easier to arrange antenna elements close.

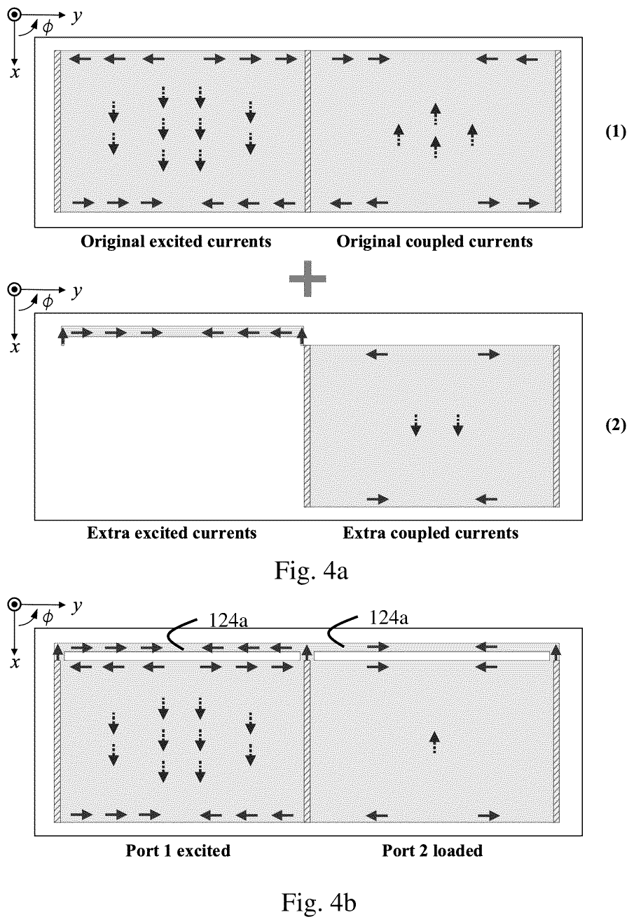

The decoupling evolution of 1×2 H-plane-coupled MAs is shown in FIGS. 4a-4b. In the example of 1×2 H-plane-coupled MAs in FIGS. 4a-4b, the patches are 19.3×28.4 mm², with a U-shaped strip width of 1.1 mm and a shorting wall width of 0.7 mm. At the very beginning, two antenna elements are directly connected along the H-plane and share the same shorting wall to reduce the overall antenna size, as shown in FIG. 4a. The dimensions of the patches and shorting walls in FIG. 4a and FIG. 4b are the same. FIG. 4a shows the current distributions of the initial design where two shorting-wall-loaded MAs are placed together. With reference to (1) of FIG. 4a, typical current distributions of a TE^{x}₁₁₀ mode can be observed in the excited element, while weaker current distributions exist in the coupled element. It should be mentioned that the coupling effect is not severe due to the blockage of the shorting wall. To further reduce the mutual coupling, a U-shaped strip 124a is attached at a radiating edge of the MA element, of which the current distributions are shown in FIG. 4b. After introducing the U-shaped microstrip stub, the current in the y-direction on the newly added stub is opposite to the current direction on the patch edge ((2) of FIG. 4a). This reverse-phase current induces an opposite current on the coupling patch compared to the original coupling current. As a result, the reverse coupling currents superimpose, leading to a decrease in the coupling current on the coupling patch (indicated by the solid and dash-line arrows). It should be noted that bilateral U-shaped strips also work, which is not shown here for brevity. Besides, the extra introduced U-shaped stub do not extend the path of the resonant current. The resonance mode of the patch loaded with a U-shaped stub is unchanged.

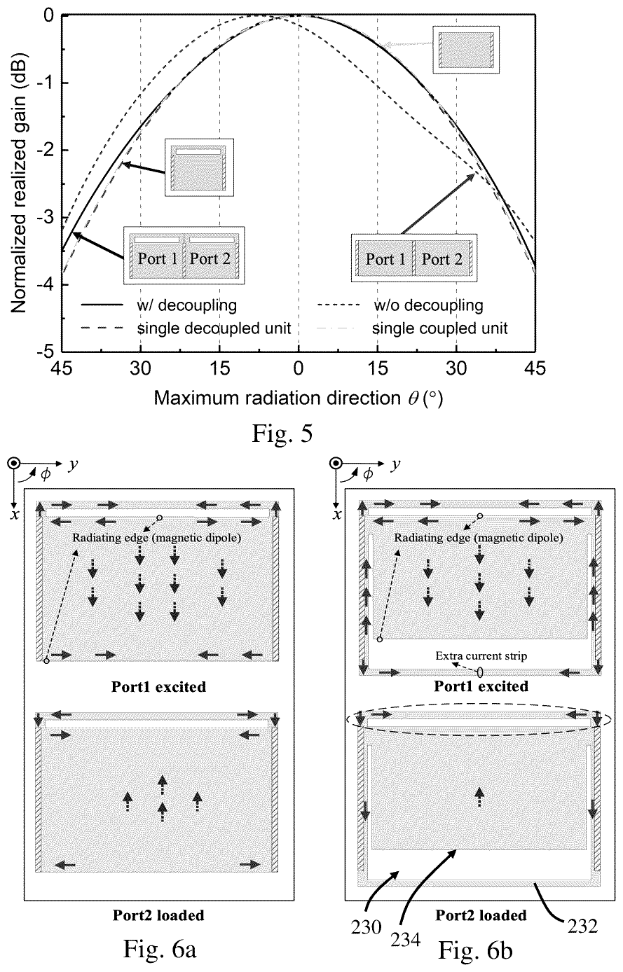

FIG. 5 shows the co-polarizations of various MAs with 1×2 configuration, and with and without the U-shaped strips. However, all the MAs shown in FIG. 5 contain two shorting wall at their non-radiating edges. The directional co-polarizations of single units are also displayed. With reference to FIG. 5, the maximum radiation direction of MA element is along θ=8° without the decoupling U-shaped strips. It can be exactly restored to θ=0° with the help of decoupling structure, verifying the RPD characteristic. As shown in FIG. 5, the element radiation pattern of the H-plane antenna pair (solid line) is essentially the same as the radiation pattern of a single decoupled antenna (dot-and-stroke line). Within the operating bandwidth, the variation in realized gain among different MA units loaded with different decoupling structures is within 0.4 dB. Their S-parameters can also be obtained, with almost the same matching and coupling levels, and thus not shown here for brevity.

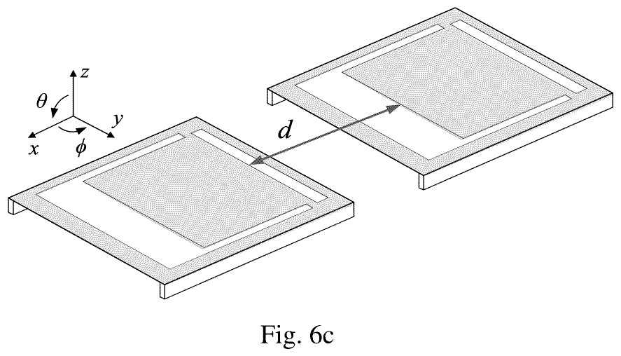

FIGS. 6a-6c show the decoupling principle for an E-plane-placed 1×2 MA pair. To extend the element design for a 2D MIMO array, the H-plane-decoupled element is used as the initial configuration, as shown in FIG. 6a. Like the decoupling principle for the H-plane case, an extra current path can be introduced by a U-shaped slot 230. The U-shaped slot 230 separates the lower side radiating edge into a new radiating edge 234 and an extra microstrip line 232. The new microstrip line 232 created by the U-shaped slot 230 introduces an extra current coupling path. The new radiating edge 234 also serves as a magnetic dipole. When the coupling currents from the radiation edges and the extra microstrip lines are opposite, the coupling current on the coupling patch is minimum. Moreover, this configuration enables the antenna unit to obtain RPD characteristics. It should be noted that the resonant frequency of the U-shaped-slot-loaded MA will increase due to the decreased side length of the MA along x-axis. However, this frequency shift can be compensated by lengthening the x-oriented slot arm of the U-shaped slot with increased current path. As shown in FIG. 6c, the new radiating edge gets far from the other element, so the port isolation can be enhanced.

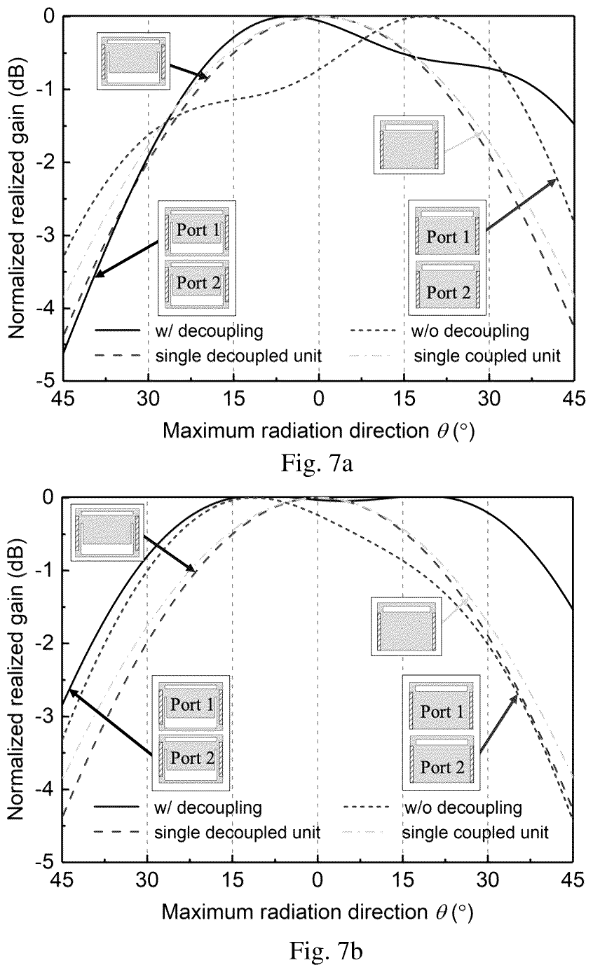

FIGS. 7a-7b show the co-polar radiation patterns at 5.8 GHz for the E-plane-placed MAs with 1×2 configuration, and with and without the U-shaped strips. However, all the MAs shown in FIGS. 7a-7b contain two shorting walls at their non-radiating edges, as well as the U-shaped strip similar to that shown in FIG. 4b. Unlike the symmetry of the H-plane case, the radiation patterns of Ports 1 and 2 will be different for the E-plane case, and displayed in FIGS. 7a and 7b, respectively. The directional co-polarizations of single units are also given. For Port 1, the maximum radiation direction can be restored from θ=18° to 5° with the introduction of the decoupling U-shaped slot, as shown in FIG. 7a. Although it is not along the zenith direction, the gain difference between θ=0° direction and the maximum θ=5° direction can be neglected with a value of only −0.06 dB. For Port 2 as shown in FIG. 7b, the maximum radiation tilts from θ=12° back to 5°, and the radiation pattern seems more symmetric. Similarly, the gain drops only 0.03 dB at the zenith direction compared to the maximum θ=5° direction. Similarly, the E-plane decoupled antenna pair also obtains RPD characteristics. Compared with a single antenna, the beamwidth of the E-plane radiation pattern of an antenna element becomes wider, regardless of whether decoupling structures are used. This is due to the change in the boundary conditions of the element in the E-plane direction. It should be noted that this decoupling structure has little influence on the H-plane case, which is suitable for 2D MIMO array design.

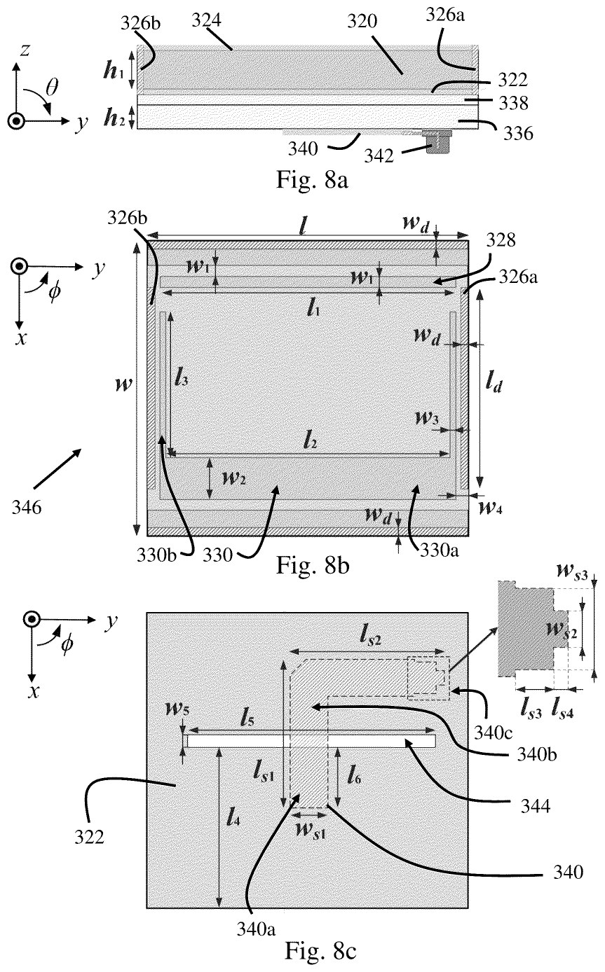

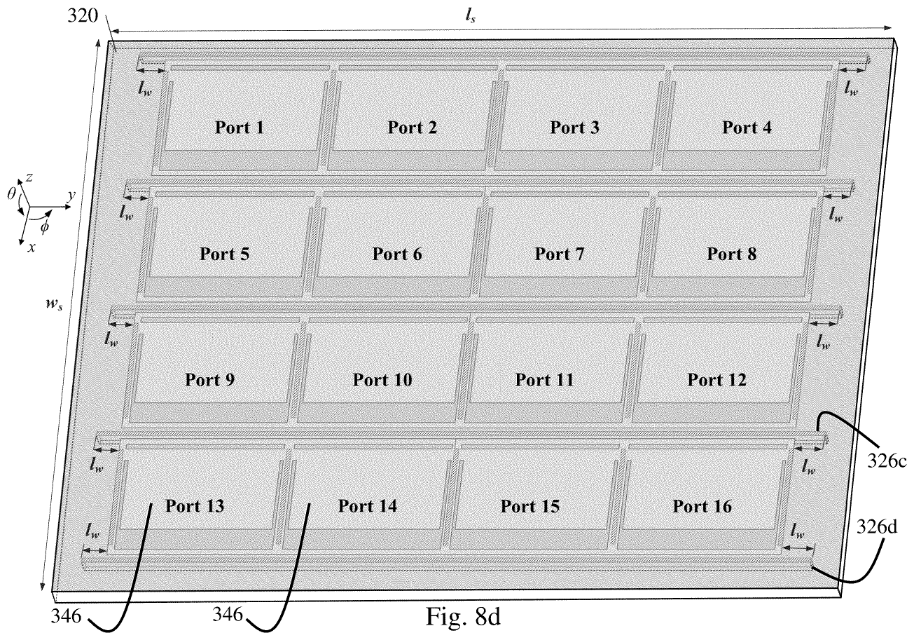

FIGS. 8a-8d show the configuration of an exemplary 4×4 MIMO MA array built on the basis of the MA shown in FIGS. 2a-2c. Each MA element 346 in the array has the same configuration as the MA in FIGS. 2a-2c at least in terms of the shape of the microstrip patch 324, as well as the shorting walls 326a, 326b at non-radiating edges of the MA element 346. However, as shown in FIG. 8a the MIMO MA array contains two substrates 320 and 336 (while FIG. 8d shows only one of them). The MIMO MA array is etched on the upper layer of the first substrate 320 (εᵣ=2.2 and tan δ=0.0009), and fed by a microstrip line 340 on the bottom layer of the second substrate 336 (εᵣ=3.55 and tan δ=0.0027). The ground 322 is configured on a second side of the first substrate 320 which is opposite to the first side of the first substrate 320 on which the microstrip patch 324 is arranged. The two substrates 320, 336 share the same dimensions of 122.5×135 mm², but with thicknesses of h₁ and h₂, respectively. These two substrates 320, 336 are bonded with a bonding film 338 having a thickness of 0.1 mm, a dielectric constant of 4.1, and a loss tangent of 0.02. FIG. 8b shows the configuration of an MA element 346 that is identical with that shown in FIG. 2b, but has a length of l and a width of w as indicated in FIG. 8b. A l₁-long w₁-wide elongated slot 328 is etched on the MA element 346 for H-plane decoupling, whereas a U-shaped slot 330 is used for E-plane decoupling as discussed in the previous section. The width of the central portion 330a of the U-shaped slot 330, which is w₂, will make the resonant frequency of the MA element 346 higher, which can be shifted back by lengthening the side portion 330b of the U-shaped slot 330 that has a length of l₃. It should be noted that two shorting walls 326a, 326b are located at the non-radiating edges of the MA elements 346 to maintain H-plane symmetry and get rid of dummy elements for MIMO array. The shorting walls 326a, 326b have a length of l_{d} and a width of w_{d}, which is compatible with printed circuit board (PCB) process.

Another pair of E-plane-placed shorting walls 326c, 326d are also used for isolation enhancement and radiation pattern uniformity. Again, the shorting walls 326c, 326d here have the same width w_{d}. With these four shorting walls 326a-326d, dummy elements can be avoided for MIMO array designs, thus making them compact. It should be noted that although in FIG. 8b it may appear that for each MA element 346 there are separate shorting walls 326c, 326d, for the 4×4 MIMO MA array each row of the MA elements 346 (there are four MA elements 346 in one row) share two shorting walls that extend in the y direction. For the sake of easy reference, FIG. 8d shows that the bottom row of the MA elements 346 share two shorting walls 326c, 326d. Each of the two shorting walls 326c, 326d extend along the y direction, and beside the four MA elements 346 in the row. As a result, the shorting walls 326c, 326d with a length of 1, are lengthened at all edges of the E-plane-place shorting walls. The length of each of the shorting walls 326c, 326d is greater than the combined length of all MA elements 346 in the row. In addition, for the four MA elements 346 in a row, every two adjacent ones are electrically connected to each other at the U-shaped strips near the two radiating edges.

It should be noted that as shown in FIG. 8d, for the five shorting walls in the array that extends in the y direction, three of them are each shared by MA elements from more than one row of MA elements, except for the very top and bottom shorting walls in the figure. Likewise, for shorting walls that extends in the x direction, most of them are each shared by two MA elements in the same row, except for the very left and right shorting walls in the figure.

As can be seen in FIG. 8c, for each of the MA elements 346, a feeding rectangular slot 344 is etched in the ground 322 with a length of l₅ and a width of w₅. To feed the MA element 346, a microstrip line 340 with a width of wₛ₁ is used, which includes a l₆-long open-circuited stub 340a, stepped impedance lines 340b for antenna impedance matching, and a connection pad 340c for the SMP connector 342, respectively. One can see from FIG. 8c that the microstrip line 340 has a substantially L shape. With this element configuration, a MIMO MA array can be obtained easily. The 4×4 MIMO array shown in FIG. 8d demonstrates how the unit cell is extended. With reference to FIG. 8d, all the shorting walls have the same width 2w_{d} due to periodicity.

To verify the design idea of the MIMO MA array in FIGS. 8a-8d, a prototype was designed for 5.8-GHz (5.725-5.850 GHz) ISM (Industrial Scientific Medical) band applications. Based on the structural parameters optimized with ANSYS HFSS, a 4×4 MIMO MA array was fabricated. Optimal design parameters for this prototype are l=28.7 mm, w=24.6 mm, l₁=27.0 mm, w₁=1.0 mm, l₂=26.0 mm, w₂=3.9 mm, l₃=13.5 mm, w₃=0.5 mm, w₄=1.2 mm, l_{d}=18.6 mm, w_{d}=0.7 mm, l₄=13.9 mm, l₅=22.7 mm, w₅=1.2 mm, l₆=3.9 mm, lₛ₁=13.8 mm, lₛ₂=14.1 mm, lₛ₃=2 mm, lₛ₄=0.7 mm, wₛ₁=3.5 mm, wₛ₂=1.4 mm, wₛ₃=3.0 mm, h₁=3.15 mm, h₂=0.76 mm, l_{w}=2.55 mm, lₛ=67.4 mm, and wₛ=54.2 mm. Then, the fabricated prototype was measured with an Agilent N5230A vector network analyzer for S-parameters, and with Satimo Starlab near-field measurement system for radiation performances. It should be noted that when a port is under test, the others should be loaded with 50Ω resistors. Because of the structural symmetry, only the results of a 2×2 subarray are given without loss of generality and conciseness, namely Ports 1, 2, 5, and 6 as shown in FIG. 8d.

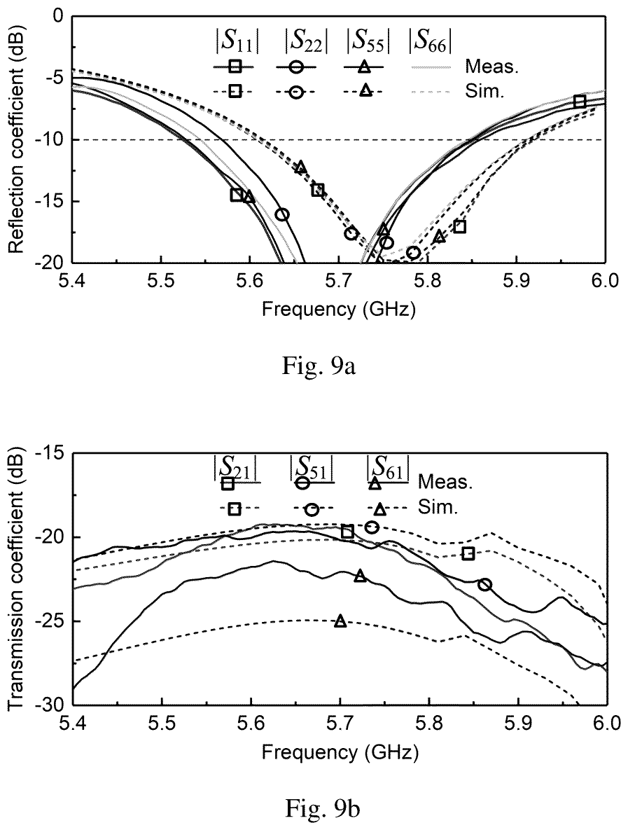

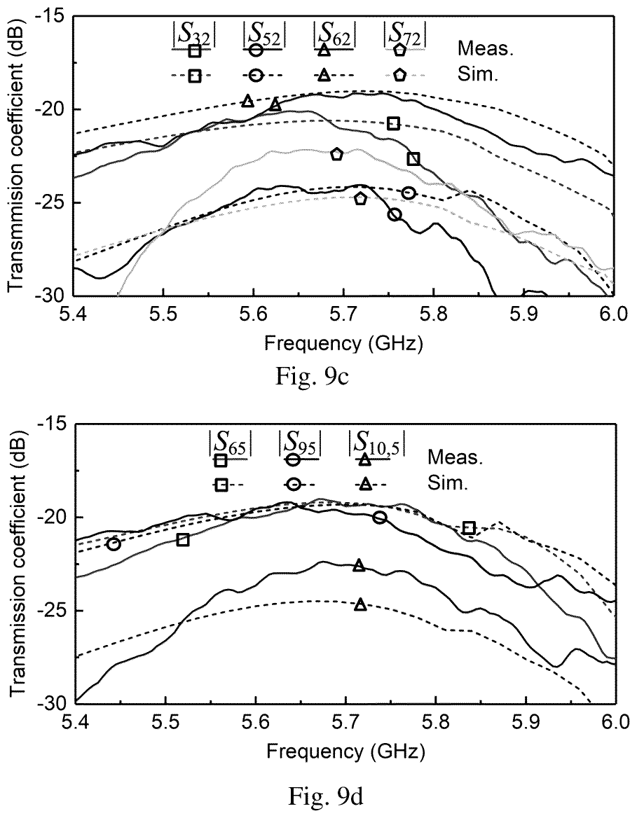

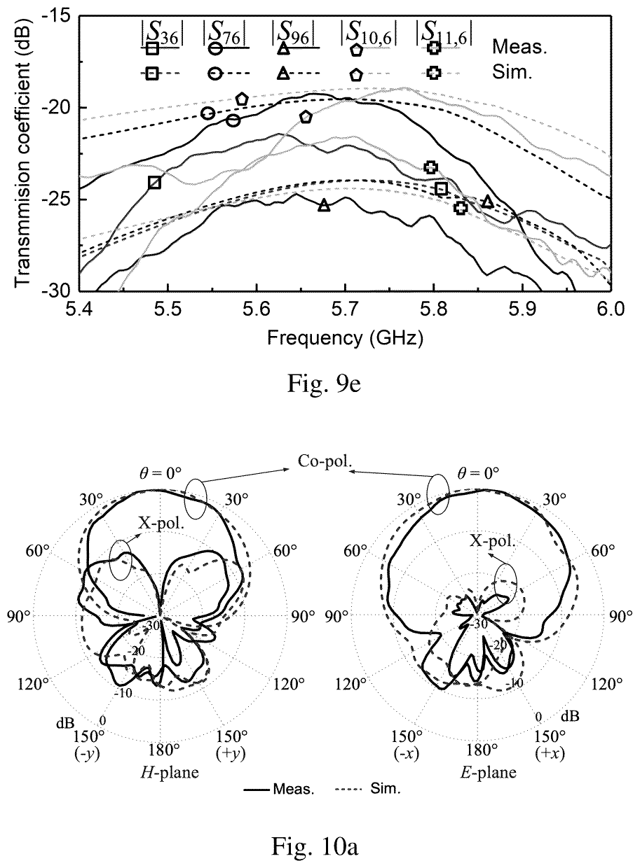

FIGS. 9a-9e show the measured and simulated S-parameters of the decoupled 4×4 MIMO MA array. With reference to FIG. 9a, the measured 10 dB overlapping impedance bandwidth of the decoupled MIMO array is 5.9% (5.53-5.87 GHz), agreeing reasonably with the simulated 5.3% (5.62-5.93 GHz). They can fully cover the desired 5.8-GHz ISM band, although there is a little frequency shift and measurement inconsistency due to fabrication tolerance and experimental errors. The relative frequency deviation of the measured results is 1.7%, which is within the acceptable range. Considering the deviation in the actual substrate thickness, the relative deviation between the simulated and measured operating frequencies is only 0.4%. For the transmission coefficients shown in FIGS. 9b-9e, the measured transmission coefficients between any two adjacent ports are lower than −18.7 dB, while simulated counterparts are lower than −18.5 dB. It should be mentioned that the mutual couplings between any two non-adjacent ports are lower than −24.4 dB, and therefore not given for brevity.

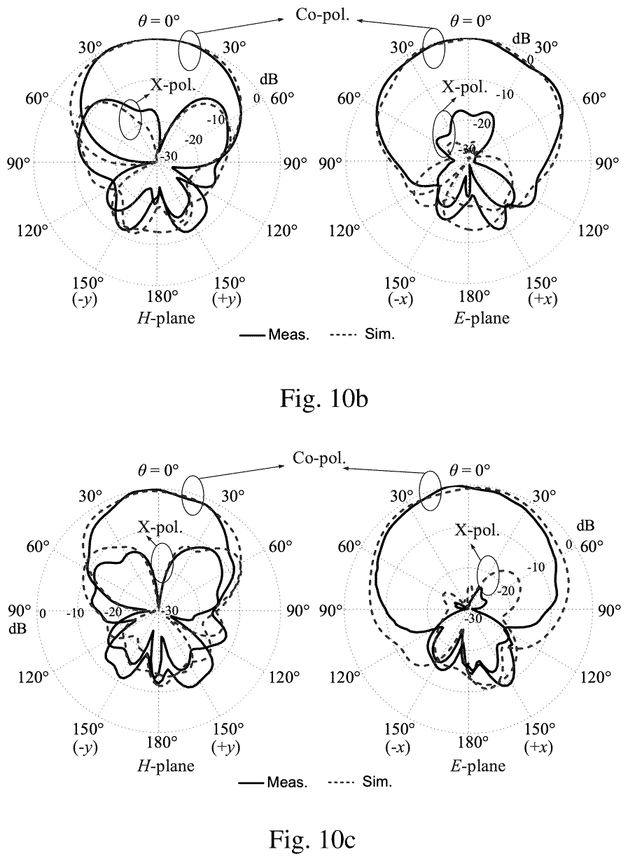

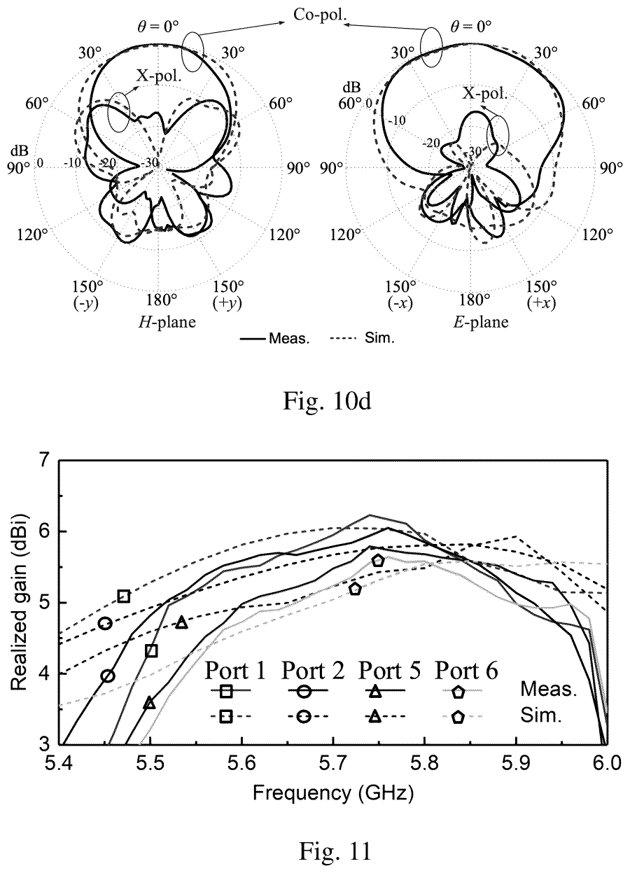

FIGS. 10a-10d show the measured and simulated radiation patterns at 5.8 GHz, where reasonable agreement can be observed. All of the measured and simulated radiation patterns are uniform unidirectional ones, suitable for MIMO antenna array. With reference to FIGS. 10a-10d, measured cross-polar levels are lower than −15 dB from −30° to 30° both on E-plane and H-plane. Also, the front-to-back ratios are larger than 15 dB, good enough for practical uses. Again, the discrepancy may be due to fabrication tolerance and experimental errors. It can be observed that the cross-polarization of the H-plane is relatively large, mainly due to the asymmetry y-directed currents on both sides of the patch. It should be highlighted that symmetric radiation patterns can be found even for Port 1. It is because each antenna element is surrounded by four symmetric shorting walls which make sure the element boundary uniformity even without dummy elements.

FIG. 11 shows the measured and simulated realized gains at the zenith direction. With reference to FIG. 11, the measured maximum realized gains of Ports 1, 2, 5, and 6 are 6.2, 6.1, 5.8, and 5.7 dBi around 5.75 GHz, respectively. In addition, all the measured realized gains are larger than 5.2 dBi, with a difference of less than 0.4 dB over the desired ISM band compared to the simulated results. It is worth mentioning that the maximum gain variation is less than 0.7 dB over the entire 5.8-GHz ISM band, which is rather uniform for MIMO application scenarios.

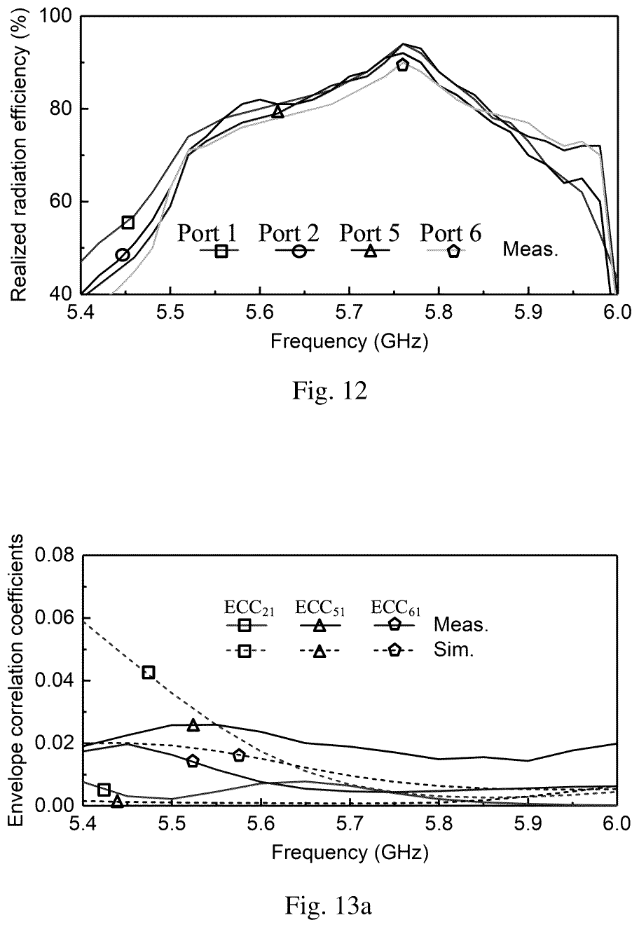

FIG. 12 shows the measured total radiation efficiencies. With reference to FIG. 12, the maximum total radiation efficiencies are larger than 90% at 5.75 GHz, high enough for practical applications. It can be also seen that the trends of these curves agree well with those of the realized gains shown in FIG. 11, as expected.

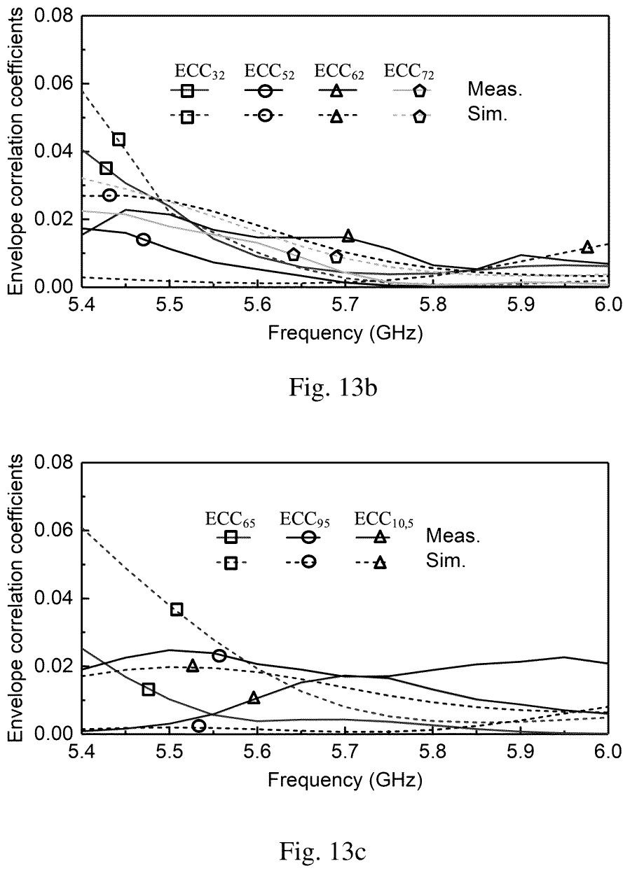

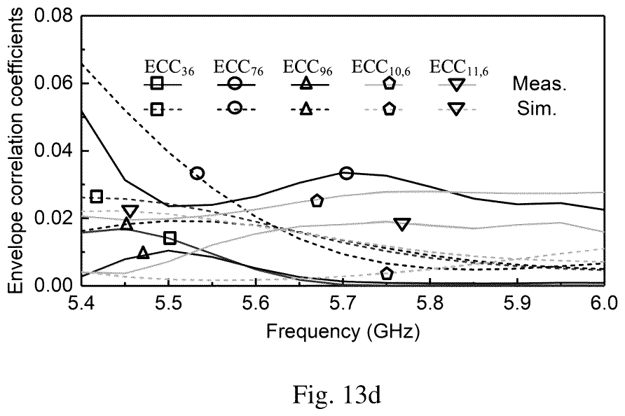

FIGS. 13a-13d compare the measured and simulated envelope correlation coefficients (ECCs), which are calculated from radiation fields [48]. As can be seen in the figure, all the measured ECCs are lower than 0.04, much lower than the criteria of 0.5 [49]. It implies the presented MA array a good MIMO antenna. In addition, the simulated ECCs between antenna elements with and without decoupling structures are 0.013 and 0.017 respectively.

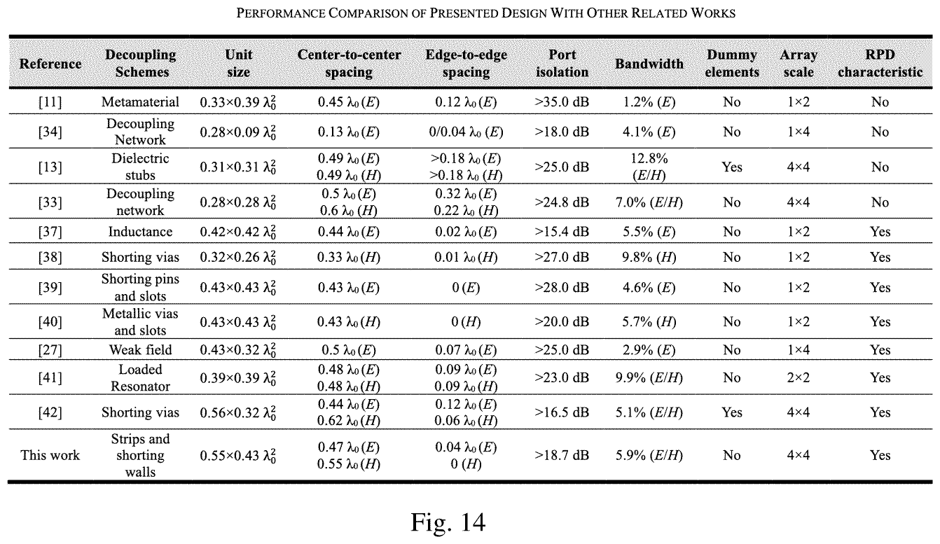

To highlight the merits of the presented decoupling scheme, Table I in FIG. 14 compares the performances of this prototype (denoted as “This work” in Table 1) with other related state-of-the-art works. With reference to Table I, [11], [13], [33], and [34] cannot realize RPD characteristics. Although RPD performances can be obtained in [38]-[40], they are 1×2 antenna pairs only. In [27], a linear MIMO antenna array can be realized, while a 2×2 design can be found in [41]. Only [42] and this work have realized large-scale 2D MIMO arrays with RPD characteristics. Compared to [42], dummy elements are no longer needed to obtain uniform radiation patterns for this work, which saves the antenna array size. Also, a smaller H-plane spacing is obtained in this paper, which further reduces the overall size of antenna. Therefore, there is provided a great scalability to the configuration of the antenna array.

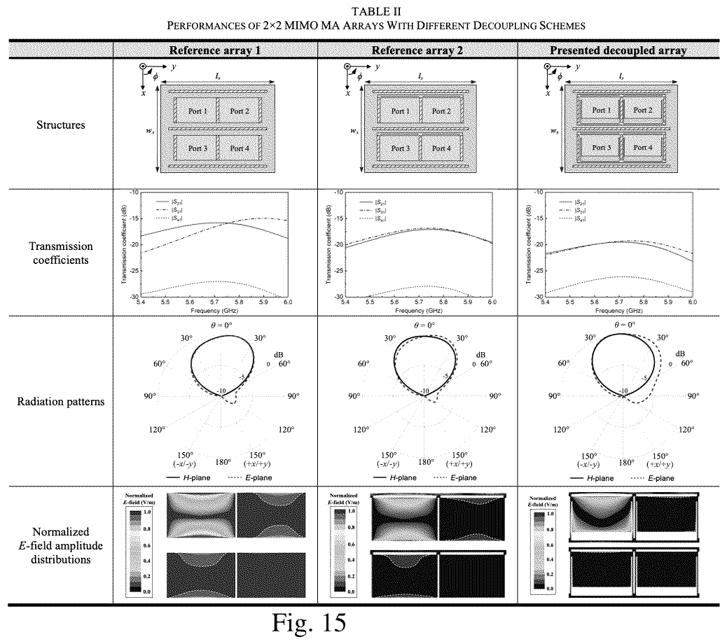

To facilitate discussion and demonstration, Table II in FIG. 15 compares the performance of different decoupling structures combined with E-plane short walls in 2×2 MIMO MA arrays. The second row of Table II shows the configurations of these three MIMO arrays in turn with a conventional MA element, an MA element with U-shaped strip, and a presented MA element. They are denoted as Reference array 1, Reference array 2, and the presented decoupled array, all of which are constructed by shorting walls. The substrate length lₛ and width wₛ of these designs are changed to 77.4 and 55.0 mm, respectively, with other design parameters the same with those of the presented 4×4 design (see caption of FIG. 7). The overlapping bandwidth of the three MIMO arrays ranges from 5.74 to 5.91 GHz. Similarly, without loss of generality, simulated results of Port 1 with other ports loaded are given. To clearly show the RPD characteristic, the radiation patterns are with a small-scale range and co-polarization only.

The third row of Table II compares the port isolations regarding Port 1 of these three 2×2 MIMO MA arrays. With reference to the subfigures where H-plane coupling is considered, the worst isolations (−|S₂₁|) inside the overlapping bandwidth (5.74-5.91 GHz) are 15.8, 17.1, and 19.6 dB for Reference array 1, Reference array 2, and the presented decoupled array, respectively. It can be found that the U-shaped strip can enhance the isolation, which verifies the H-plane decoupling idea. For the −|S₃₁|s, the isolations can be enhanced from 16.8 to 19.3 dB when extra U-shaped slot is considered, verifying the E-plane decoupling philosophy. Since the U-shaped slot makes the current on its x-direction arm closer to the diagonal element, the −|S₄₁| of the presented array is slightly worse than that of the Reference array 1. However, it still remains more than 25 dB. Compared to vertically (E-plane) coupled cases and horizontally (H-plane) coupled cases, the isolation between diagonal elements are at least higher than 5 dB. Therefore, it can be ignored in the design process.

The fourth row of Table II shows their simulated radiation patterns at 5.75 GHz. As can be seen in the row, Reference array 1 has tilting angles of ˜15° in each cutting plane. After adding U-shaped strips, the H-plane radiation pattern can be restored. With both U-shaped strips and slots, the maximum radiation is along the zenith direction again, which means the RPD characteristic.

The fifth row of Table II lists the normalized E-field amplitude distributions under the MAs as Port 1 is excited. With reference to the table, E-field distributions can be found almost the same as those of the TE₁₁₀^{x} mode. Because of the U-shaped slot, the E-field distributions around the slot change a little, but those near the U-shaped strip keep unchanged. It can be verified as the TE₁₁₀^{x} mode. It should be noticed that the overall E-fields remain little under Elements 2, 3, and 4 for the decoupled MIMO array, which implies the RPD characteristics.

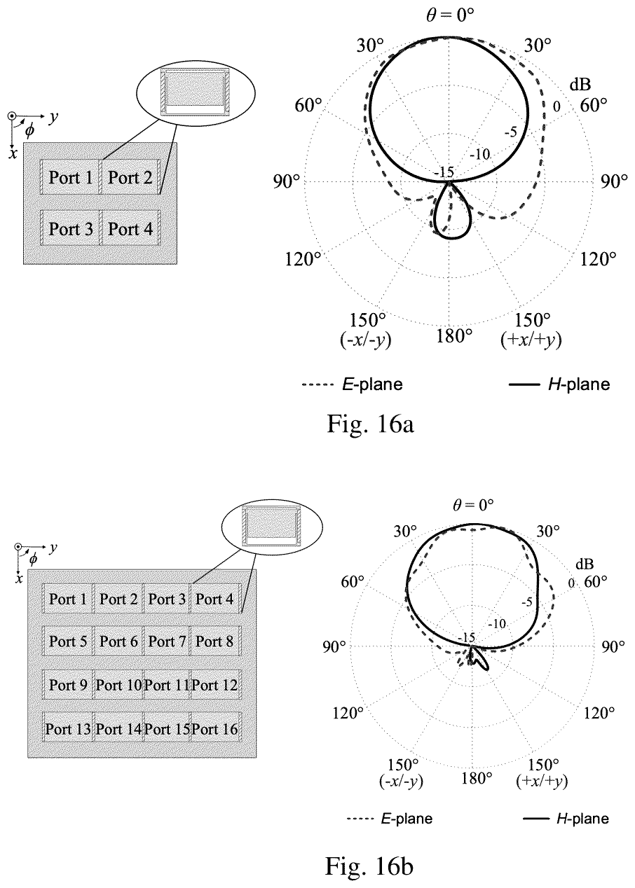

FIGS. 16a-16b show the effects of the E-plane-placed shorting walls on the radiation patterns. FIGS. 16a and 16b display the simulated radiation patterns of Port 1 at 5.75 GHz for 2×2 and 4×4 MIMO MA arrays without loading E-plane-placed shorting walls, respectively. With reference to FIG. 16a, for a 2×2 MIMO MA array, the H-plane radiation pattern of element remains unchanged, but that of E-plane tilts to θ=9°. It can be predicted since the absence of E-plane shorting walls cannot suppress E-plane surface waves which degrade the E-plane radiation patterns [50]. This phenomenon gets even worse with a larger 4×4 MIMO array, where ripples can be found in the E-plane radiation pattern as shown in FIG. 16b. Therefore, it has been clearly verified that the presented E-plane-placed shorting walls contribute to boundary uniformity and RPD characteristic.

In summary, one can see that exemplary embodiments of the invention provide compact 2D MIMO MA arrays without dummy elements with RPD characteristic. With H-plane-placed shorting walls, the MA element works under its TE₁₁₀^{x} mode. With U-shaped strips, extra coupling current path can be introduced to cancel the existing H-plane-coupled current. Also, U-shaped slots are used to separate the radiating edge into a new radiating edge and an extra current strip. Again, extra current path can be obtained for the E-plane case, and destructive superposition will result in RPD characteristic. Four shorting walls have been used to obtain boundary uniformity for each element even without using dummy elements. To verify the design idea, a 4×4 MIMO MA array has been designed, fabricated, and measured, with good agreement between measurement and simulation results. The measured overlapping impedance bandwidth is 5.9% (5.53-5.87 GHz), over which the isolations are all higher than 18.7 dB. The measured realized gains are higher than 5.2 dBi inside the desired ISM band, with a gain difference between any two ports of less than 0.7 dB. The peak total radiation efficiencies are higher than 90%, while the ECCs are lower than 0.04. It should be highlighted that all the elements have the uniform radiation patterns along the zenith direction without dummy elements.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

What is claimed is:

1. A microstrip antenna, comprising:
a) a substrate;
b) a microstrip patch configured on a first side of the substrate;
c) a ground configured on a second side of the substrate which is opposite to the first side; and
d) a first shorting wall extending from a side of the microstrip patch toward the ground;
wherein the first shorting wall substantially overlaps with the substrate on a direction that is perpendicular to the microstrip patch; the first shorting wall located at a first non-radiating edge of the microstrip antenna.

2. The microstrip antenna of claim 1, wherein the first shorting wall is located at an edge of the microstrip patch.

3. The microstrip antenna of claim 1, further comprises a second shorting wall that extends from the side of the microstrip patch toward the ground; the second shorting wall being symmetrical to the first shorting wall and located at a second non-radiating edge of the microstrip antenna that is opposite to the first non-radiating edge.

4. The microstrip antenna of claim 1, wherein the microstrip patch is formed with a U-shaped strip near a first radiating edge of the microstrip antenna.

5. The microstrip antenna of claim 1, wherein the microstrip patch is formed with a U-shaped slot, with a central portion of the U-shaped slot located near a second radiating edge of the microstrip antenna.

6. The microstrip antenna of claim 5, wherein for the U-shaped slot, the central portion has a width greater than that of two side portions of the U-shaped slot; the central portion connecting the two side portions.

7. The microstrip antenna of claim 5, wherein the U-shaped slot further comprises two side portions with the central portion connecting the two side portions; the first shorting wall located near one of the two side portions of the U-shaped slot.

8. The microstrip antenna of claim 7, wherein the one of the two side portions of the U-shaped slot is located inwardly of the first shorting wall toward a center of the microstrip patch.

9. The microstrip antenna of claim 5, wherein the microstrip patch is formed with a U-shaped strip near a first radiating edge of the microstrip antenna which is opposite to the second radiating edge.

10. The microstrip antenna of claim 9, wherein the U-shaped strip forms an elongated slot the length of which is substantially the same as a span of the U-shaped slot in the direction along which the central portion extends.

11. The microstrip antenna of claim 3, further comprises third and fourth shorting walls that extends from the side of the microstrip patch toward the ground; the third shorting wall being substantially symmetrical to the fourth shorting wall about a center of the microstrip patch; the third and fourth shorting walls being perpendicular to the first and second shorting walls.

12. A microstrip antenna array, comprising:
a) a first substrate;
b) an even number of microstrip patches configured on a first side of the first substrate;
c) a ground configured on a second side of the first substrate which is opposite to the first side;
wherein each one of the microstrip patches comprises a first shorting wall extending from a side of the microstrip patch toward the ground; wherein the first shorting wall substantially overlaps with the first substrate on a direction that is perpendicular to the microstrip patch;
the first shorting wall located at a first non-radiating edge of the microstrip patch.

13. The microstrip antenna array of claim 12, wherein each one of the microstrip patches further comprises a second shorting wall that extends from the side of the microstrip patch toward the ground; the second shorting wall being symmetrical to the first shorting wall and located at a second non-radiating edge of the microstrip patch that is opposite to the first non-radiating edge.

14. The microstrip antenna array of claim 12, wherein each of the microstrip patches is formed with a U-shaped strip near a first radiating edge of the microstrip patch.

15. The microstrip antenna array of claim 12, wherein each of the microstrip patches is formed with a U-shaped slot, with a central portion of the U-shaped slot located near a second radiating edge of the microstrip patch.

16. The microstrip antenna array of claim 12, further comprises a third shorting wall that is substantially perpendicular to the first shorting wall; the third shorting wall extending beside at least two of the microstrip patches that are aligned side by side with each other.

17. The microstrip antenna array of claim 12, wherein at least two of the microstrip patches are electrically connected to each other at a location near the first shorting wall.

18. The microstrip antenna array of claim 12, further comprises a second substrate; the ground located between the first substrate and the second substrate; the ground configured on a first side of the second substrate.

19. The microstrip antenna array of claim 18, wherein the first substrate and the second substrate are bonded by a bonding film.

20. The microstrip antenna array of claim 18, further comprises a microstrip line located at a second side of the second substrate which is opposite to the first side of the second substrate.

21. The microstrip antenna array of claim 20, wherein the microstrip line has a substantially L shape.

22. The microstrip antenna array of claim 20, wherein the microstrip line comprises an open-circuited stub and stepped impedance lines.
